(19) United States
(12) Patent Application Publication
(10) Pub. No.: US 2025/0017362 A1
(43) Pub. Date: Jan. 16, 2025

(54) Motorized Cleaning Brush Device

(71) Applicant: James Orams, Palm Coast, FL (US)

(72) Inventor: James Orams, Palm Coast, FL (US)

(21) Appl. No.: 18/419,627

(22) Filed: Jan. 23, 2024

Related U.S. Application Data
(60) Provisional application No. 63/513,223, filed on Jul. 12, 2023.

(51) Int. Cl. A46B 13/04; A46B 5/00; A46B 11/00; A46B 13/00; A47L 1/05; B25G 1/04

(52) U.S. Cl. CPC A46B 13/04; A46B 5/0058; A46B 11/002; A46B 13/008; A47L 1/05; B25G 1/04; A46B 2200/3046

(57) ABSTRACT

A motorized cleaning brush device is provided. The device is comprised of a body that may be telescoping to allow the head of the device to clean hard-to-reach surfaces, such as the windshields of commercial vehicles. The head is further comprised of an at least one bristles that may be spun via a motor to thoroughly clean any surface. The bristles may act with a cleaning solution expelled from the head of the device via an at least one nozzle to clean any surface known in the art.

### CROSS-REFERENCE TO RELATED APPLICATION

The present application claims priority to, and the benefit of, U.S. Provisional Application No. 63/513,223, which was filed on Jul. 12, 2023, and is incorporated herein by reference in its entirety.

### FIELD OF THE INVENTION

The present invention relates generally to the field of cleaning devices. More specifically, the present invention relates to a motorized cleaning brush device that can be used to clean hard-to-reach surfaces, such as the windshields of commercial vehicles. The head is further comprised of an at least one bristles that may be spun via a motor to thoroughly clean any surface. Accordingly, the present disclosure makes specific reference thereto. Nonetheless, it is to be appreciated that aspects of the present invention are also equally applicable to other like applications, devices, and methods of manufacture.

### BACKGROUND

While driving on the road, it's an unavoidable fact that vehicle windshields will become marred with a combination of insects, natural environmental elements, dust, smudges, and various other types of debris. Over time, this accumulation can become a considerable hindrance. Though vehicles are equipped with windshield cleaning fluid and wipers, these standard features often fall short of completely clearing away the stubborn grime, residue, and spots that can accumulate. This inability to achieve a crystal-clear windshield can seriously impact the driver's visibility, making it challenging to have an unobstructed view of the road ahead, which is crucial for safe driving.

For commercial truck drivers, the challenge is further intensified. Given the size and elevation of their vehicles, reaching the entirety of the windshield using standard cleaning tools becomes a difficult task. This can sometimes leave them with a less-than-optimal view, potentially compromising their safety and that of other road users.

Therefore, there exists a long-felt need in the art for a device that can effectively clean hard-to-reach areas. More specifically, there exists a long-felt need in the art for a motorized cleaning brush device that can extend to easily clean the windshield of commercial trucks, which are typically out of reach. Furthermore, there exists a long-felt need in the art for a motorized cleaning brush device that prevents additional stress and strain from being acted upon by the user of the device when cleaning hard-to-reach areas.

The subject matter disclosed and claimed herein, in one embodiment thereof, comprises a motorized cleaning brush device. The device is comprised of a hollow, telescoping rod-like body in which a cleaning solution may be poured into and pumped out by activating a button on the handle of the first end of the body. The device is further comprised of a head that can be used to thoroughly remove debris and wipe dry typically out-of-reach surfaces. The head is further comprised of bristles attached to a motor that can remove dirt and debris from surfaces without providing additional stress and strain onto the joints of the user.

In this manner, the motorized cleaning brush device of the present invention accomplishes all the forgoing objectives and provides a device that can effectively clean hard-to-reach areas. More specifically, the motorized cleaning brush device can extend to the windshield of commercial trucks to remove dirt and debris from the windshield. Furthermore, the motorized cleaning brush device is motorized, preventing additional stress and strain from acting upon the joints of the user of the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized cleaning brush device primarily comprised of a body, a head, and a motor. The device may also have multiple brushes. The device is designed to clean hard-to-reach surfaces, such as the windshields of commercial trucks, easily without placing additional stress or strain on the user. The device may be used in automobiles, homes, and/or buildings due to its extendable handle.

The device is comprised of a rod-like body that is hollow and is preferably made from a plastic or lightweight metal material. The body may be telescoping, allowing for the length of the body to be changed at the discretion of the user. The body may further be comprised of a first end from which a cleaning solution may be poured into the hollow space of the body. A cap may be attached to the first end to prevent the cleaning solution from inadvertently spilling out of the body. The first end is further comprised of a handle from which a user may press a button to operate a pump, spraying the cleaning solution onto the surface that is to be cleaned.

A second end may be attached to the body via a pivot point that allows the second end to rotate about the body to better conform to any surface to be cleaned. The second head may be further comprised of at least one bristle that may clean the surface. The bristles may be connected to a motor that can spin the bristles, providing a deeper clean to the surface. The head may further be comprised of at least one nozzle, from which the cleaning solution may be sprayed, and a cleaning blade to dry and clean the surface once the bristles have loosened or removed the dirt or other debris from the surface.

The present invention is also comprised of a method of using the device. First, a device is provided comprised of a body, a head, and a motor. Then, the body may be filled with a cleaning solution and secured in the body by securing the fastener of the cap to the fastener of the first end of the body. Then, the body may be extended to a desired length by the user and fixed to that length via the locking member. Next, the second end may be rotated to a desired angle about the pivot point and locked to that angle via the locking member of the second end. Then, the button of the handle may be pressed, activating the pump to push the cleaning solution through the nozzle and onto the windshield of a commercial vehicle. Next, the button may further be pressed to activate the motor, spinning the bristles to remove dirt and debris from the windshield of a commercial vehicle.

The present invention is also comprised of a second method of using the device. First, a device is provided comprised of a body, a head, and a motor. Then, the body may be filled with a cleaning solution and secured in the body by securing the fastener of the cap to the fastener of the first end of the body. Then, the body may be extended to a desired length by the user and fixed to that length via the locking member. Next, the second end may be rotated to a desired angle about the pivot point and locked to that angle via the locking member of the second end. Then, the button of the handle may be pressed, activating the pump to push the cleaning solution through the nozzle and onto the windshield of a commercial vehicle. Next, the button may further be pressed to activate the motor, spinning the bristles to remove dirt and debris from the windshield of a commercial vehicle. Finally, the cleaning blade may be scraped along the surface to remove any remaining water, cleaning solution, dirt, or other debris from the windshield.

Accordingly, the motorized cleaning brush device of the present invention is particularly advantageous as it provides a device that can effectively clean hard-to-reach areas. More specifically, the motorized cleaning brush device is motorized, providing a deep clean to any surface without adding stress or strain to the user of the device. Furthermore, the motorized cleaning brush device can extend in length, allowing for hard-to-reach areas, such as the windshields of commercial vehicles, to be easily cleaned. In this manner, the motorized cleaning brush device overcomes the limitations of existing cleaning devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized cleaning brush device of the present invention in accordance with the disclosed architecture;

FIG. 2 illustrates an enhanced perspective view of a first end of one potential embodiment of a motorized cleaning brush device of the present invention in accordance with the disclosed architecture;

FIG. 3 illustrates an enhanced perspective view of a second end of one potential embodiment of a motorized cleaning brush device of the present invention in accordance with the disclosed architecture;

FIG. 4 illustrates an enhanced perspective view of a second end one potential embodiment of a motorized cleaning brush device of the present invention in accordance with the disclosed architecture;

FIG. 5 illustrates a flowchart of a method of using one potential embodiment of a motorized cleaning brush device of the present invention in accordance with the disclosed architecture; and

FIG. 6 illustrates a flowchart of a second method of using one potential embodiment of a motorized cleaning brush device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can effectively clean hard-to-reach areas. More specifically, there exists a long-felt need in the art for a motorized cleaning brush device that can extend to easily clean the windshield of commercial trucks, which are typically out of reach. Furthermore, there exists a long-felt need in the art for a motorized cleaning brush device that prevents additional stress and strain from being acted upon the user of the device when cleaning hard-to-reach areas.

The present invention, in one exemplary embodiment, is comprised of a motorized cleaning brush device. The device is primarily comprised of a body, a head, and a motor. The device is designed to clean hard-to-reach surfaces, such as the windshields of commercial trucks, easily without placing additional stress or strain on the user.

More specifically, the device is comprised of a body that is preferably hollow and made from a plastic or lightweight metal material. The body may further be comprised of a locking member and an at least one fastener. In one potential embodiment, the body of the device may be telescoping, allowing the body to extend in length. The locking member, in this embodiment, may be used to temporarily fix the length of the body.

The body may be further comprised of a first end from which the fastener of the body may attach to a fastener of a cap. A cleaning solution may be placed into the hollow inside of the body and be secured in the body by securing the cap to the first end via the fastener of the body and the fastener of the cap attaching. The fastener of the body and the fastener of the cap are preferably male and female threads, respectively, but may be any reciprocating fasteners known in the art. The first end of the body may be further comprised of a grip area of a handle from which a user may operate the device. The handle may be further comprised of a button that, when pressed, dispenses the cleaning solution from a second end of the body.

The second end may be fixedly or removably attached to the body via a pivot point and a locking member that allows the second end to rotate and be fixed at an at least one specific angle away from the body. At least one head may be fixedly or removably attached to the second end. The head may be further comprised of at least one bristle, at least one nozzle, and at least one cleaning blade. The bristles may be rubbed along a surface to clean the surface. The nozzle allows the cleaning solution inside of the body to be sprayed onto the surface to further remove dirt and other debris from the surface. The cleaning blade may be scraped along the surface to be cleaned such that the cleaning solution and other debris that was cleaned may be removed from the surface.

The device may be further comprised of a motor and a pump that allow surfaces to be more easily cleaned by the user. The motor may spin the bristles such that the bristles can scrub the surface that is being cleaned. The pump may push the cleaning solution inside of the body out of the nozzle onto the surface. By pressing the button of the handle, the pump may be activated to spray cleaning solution onto the surface. In one potential embodiment, the button may further control the motor to activate the spinning motion of the bristles as well as control the spin speed and direction of spin. The button may be comprised of a plurality of buttons or other actuators that, when activated, control different aspects of the motor, pump, or other parts of the device. The motor and pump may be powered via a battery. The battery may be comprised of a charging port that can accept a charging cord to supply the battery with power. The battery may store that power and transfer it to the motor and/or pump when required by the user.

The present invention is also comprised of a method of using the device. First, a device is provided comprised of a body, a head, and a motor. Then, the body may be filled with a cleaning solution and secured in the body by securing the fastener of the cap to the fastener of the first end of the body. Then, the body may be extended to a desired length by the user and fixed to that length via the locking member. Next, the second end may be rotated to a desired angle about the pivot point and locked to that angle via the locking member of the second end. Then, the button of the handle may be pressed, activating the pump to push the cleaning solution through the nozzle and onto the windshield of a commercial vehicle. Next, the button may further be pressed to activate the motor, spinning the bristles to remove dirt and debris from the windshield of a commercial vehicle.

The present invention is also comprised of a second method of using the device. First, a device is provided comprised of a body, a head, and a motor. Then, the body may be filled with a cleaning solution and secured in the body by securing the fastener of the cap to the fastener of the first end of the body. Then, the body may be extended to a desired length by the user and fixed to that length via the locking member. Next, the second end may be rotated to a desired angle about the pivot point and locked to that angle via the locking member of the second end. Then, the button of the handle may be pressed, activating the pump to push the cleaning solution through the nozzle and onto the windshield of a commercial vehicle. Next, the button may further be pressed to activate the motor, spinning the bristles to remove dirt and debris from the windshield of a commercial vehicle. Finally, the cleaning blade may be scraped along the surface to remove any remaining water, cleaning solution, dirt, or other debris from the windshield.

Accordingly, the motorized cleaning brush device of the present invention is particularly advantageous as it provides a device that can effectively clean hard-to-reach areas. More specifically, the motorized cleaning brush device can change its length to reach typically out-of-reach areas and provide a deep and thorough clean to those areas. Furthermore, the motorized cleaning brush device can spin, allowing for surfaces to be easily cleaned without providing additional stress or strain on the joints of the user. In this manner, the motorized cleaning brush device overcomes the limitations of existing cleaning devices known in the art.

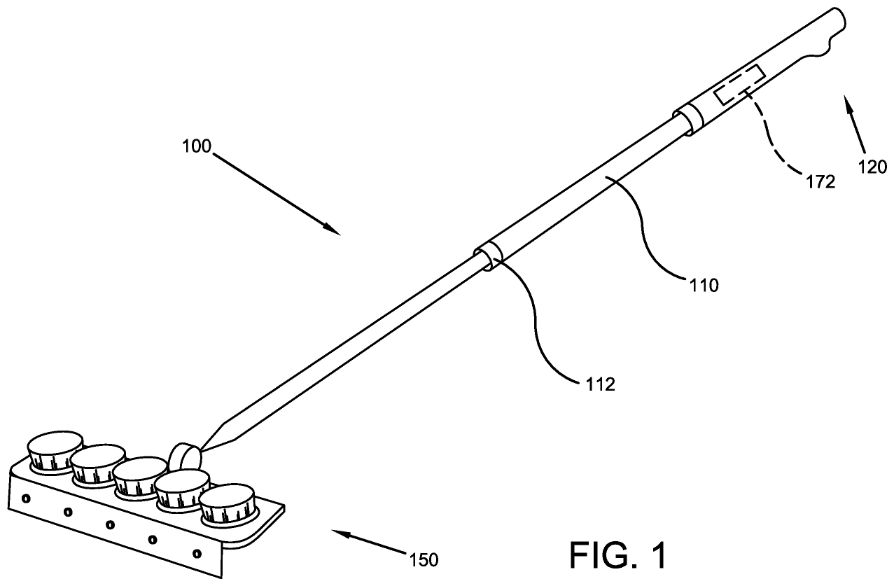

Referring initially to the drawings, FIG. 1 illustrates a perspective view of one potential embodiment of a motorized cleaning brush device 100 of the present invention in accordance with the disclosed architecture. The device 100 is primarily comprised of a body 110 with at least one head 160, and at least one motor 170. The device 100 is designed to clean hard-to-reach surfaces, such as but not limited to the windshields of commercial trucks, easily without placing additional stress or strain on the user.

The device 100 is comprised of a hollow body 110 that may be made from any material but is preferably made from a plastic or lightweight metal material, such as but not limited to aluminum. The body 110 may further be telescopic such that the length of the body 110 may be lengthened or shortened at the discretion of the user to reach cleaning areas of various heights. The body 110 is further comprised of at least one locking member 112 that, when activated, may temporarily lock the length of the body 110 at a desired length. The locking member 112 may be any type known in the art such as but not limited to a ring lock, a button, a clip, etc.

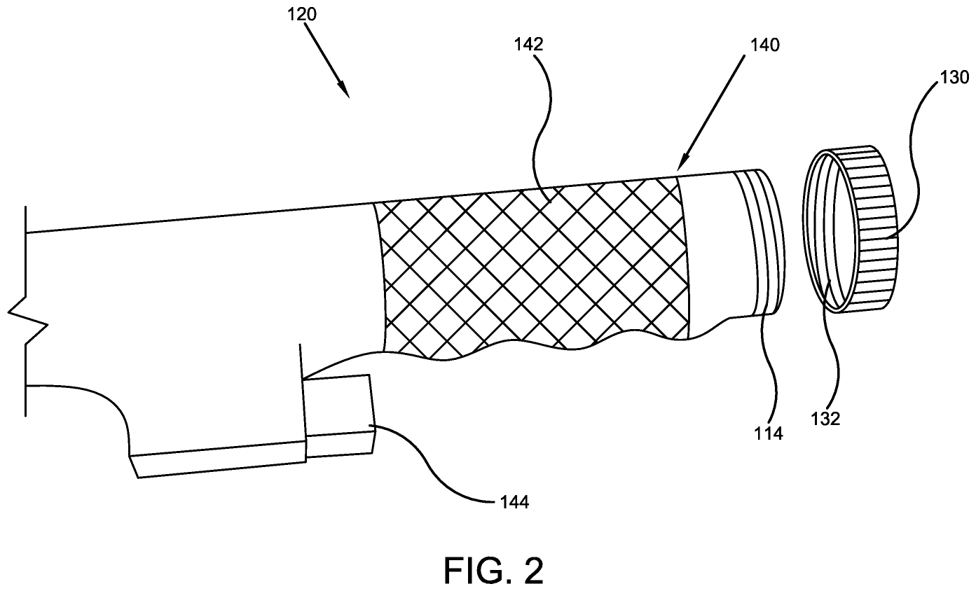

FIG. 2 illustrates an enhanced perspective view of a first end 120 of one potential embodiment of a motorized cleaning brush device 100 of the present invention in accordance with the disclosed architecture. The body 110 is further comprised of a first end 120 in which at least one fastener 114 may attach a cap 130 to the first end 120 of the body 110. The fastener 114 of the body 110 is preferably male threads. The cap 130 may be further comprised of a fastener 132 that are preferably female threads such that the cap 130 may be easily secured to the first end 120 of the body 110. The fasteners 114, 132 may, in differing embodiments, be any reciprocating fastener known in the art. The cap 130 may be detached from the first end 120 to allow a cleaning solution to be inserted into the hollow space of the body 110. The cap 130, when attached, may prevent the cleaning solution from inadvertently leaving the body 110.

The first end 120 may be further comprised of a handle 140 in which the user may operate the device 100. The handle 140 may be further comprised of a grip area 142 to allow the user to easily grip the device 100. The grip area may be comprised of a differing material, such as a non-slip rubber, and/or be comprised of a raised or recessed texture that aids in grip or better conforms to the human hand. During use, a button 144 of the handle 140 may be pressed to operate a pump 172 of the device 100 that pushes a cleaning solution from the body 110 onto the surface in which the device 100 is being used to clean.

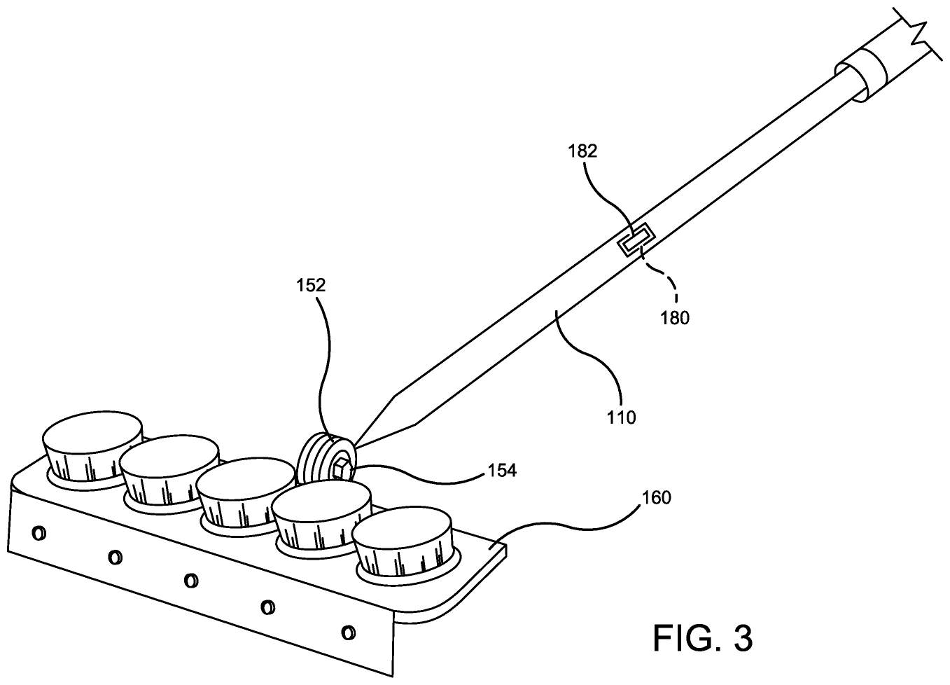

FIG. 3 illustrates an enhanced perspective view of a second end 150 of one potential embodiment of a motorized cleaning brush device 100 of the present invention in accordance with the disclosed architecture. The second end 150 may be fixedly or removably attached to the body 110 via at least one pivot point 152. The pivot point 152 may allow the second end 150 to rotate in a single direction, such as a hinge, or in multiple directions similar to a ball-and-socket joint, in differing embodiments. The angle and direction in which the second end 150 is rotated may be temporarily fixed by activating at least one locking member 154 of the second end 150, such as but not limited to a ring lock, a button, a clip, etc.

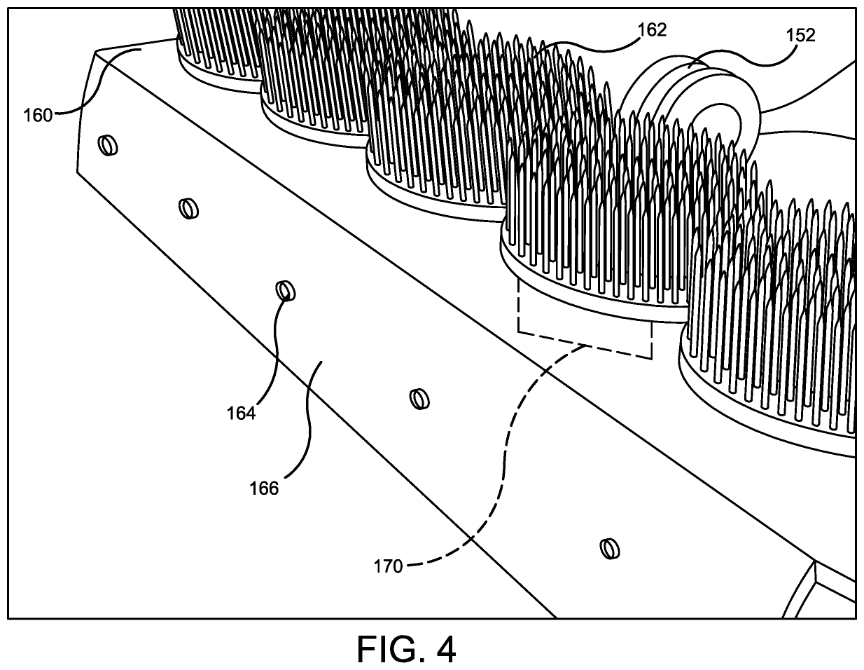

At least one head 160 may be fixedly or removably attached to the second end 150, as best seen in FIG. 4. The head 160 may be further comprised of at least one bristle 162, at least one nozzle 164, and at least one cleaning blade 166. The bristle 162 may be powered by the motor 170 such that the bristles 162 may spin (i.e. rotate 360 degrees) to clean a surface more easily. In one potential embodiment, the bristles 162 may be removable such that the bristles 162 may be replaced when they become dirty or worn. In another potential embodiment, the entire head 160 may be replaced.

At least one nozzle 164 of the head 160 allows the cleaning solution to be pushed via the pump 172 and exit the body 110 to be sprayed onto the surface. In one potential embodiment, the motor 170 and the pump 172 may both be controlled by the button 144 of the handle 140 such that the button 144 being pressed may activate both the pump 172 and the motor 170. In another potential embodiment, the button 144 may be comprised of multiple buttons 144 or actuators that each control separate aspects of the device 100 such as the activation of the pump 172, motor 170, and/or spinning of the bristles 162.

The head 160 may also be comprised of at least one cleaning blade 166 that may be scraped along the surface that is being cleaned to further remove any water, cleaning solution, dirt, or other debris that may remain. The device 100 may also be comprised of at least one battery 180 that may be supplied power via a charging port 182, such as but not limited to a USB port. The battery 180 may then supply power, which it has stored, to the motor 170, the pump 172, or any other aspect of the device 100. The battery 180 may be removable/non-removable and rechargeable/disposable in different embodiments.

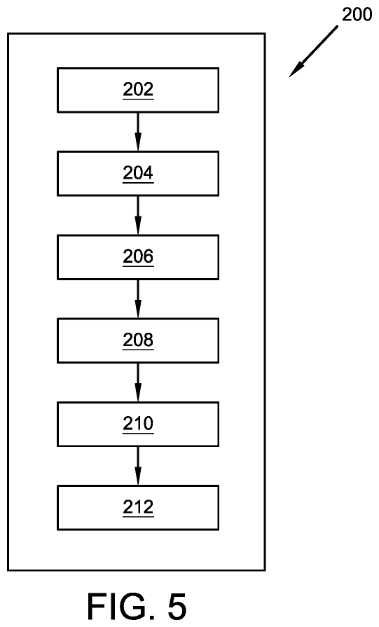

The present invention is also comprised of a method 200 of using the device 100, as seen in FIG. 5. First, a device 100 is provided comprised of a body 110, at least one head 160 comprised of at least one bristle 162, and at least one motor 170 [Step 202]. Then, the body 110 may be filled with at least one liquid cleaning solution which is secured within the body 110 by attaching the fastener 132 of the cap 130 to the fastener 114 of the first end 120 of the body 110 [Step 204]. Then, the body 110 may be extended to a desired length by the user and fixed at said length via the locking member 112 [Step 206]. Next, the second end 150 may be rotated to a desired angle about the pivot point 152 and locked to said angle via the locking member 154 of the second end 150 [Step 208]. Then, the button 144 of the handle 140 may be pressed, activating the pump 172 to push the cleaning solution through the nozzle 164 and onto a cleaning surface, such as but not limited to the windshield of a commercial vehicle [Step 210]. Next, the button 144 may be pressed to activate the motor 170 which spins the bristles 162 to remove dirt and debris from the windshield of a commercial vehicle [Step 212].

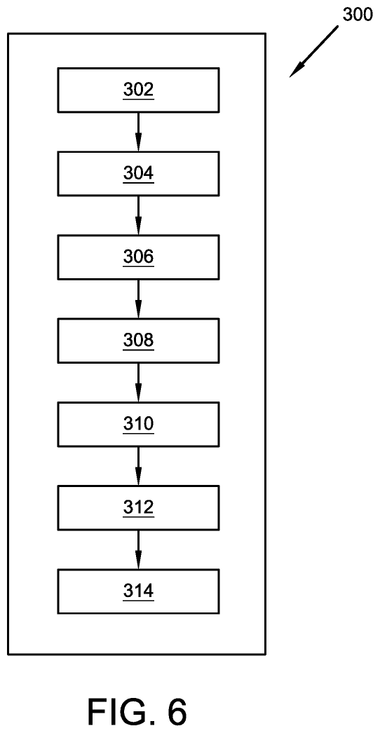

The present invention is also comprised of a second method 300 of using the device 100, as seen in FIG. 6. First, a device 100 is provided comprised of a body 110, at least one head 160 comprised of at least one bristle 162, at least one cleaning blade 166, and at least one motor 170 [Step 302]. Then, the body 110 may be filled with at least one liquid cleaning solution which is secured within the body 110 by attaching the fastener 132 of the cap 130 to the fastener 114 of the first end 120 of the body 110 [Step 304]. Then, the body 110 may be extended to a desired length by the user and fixed at said length via the locking member 112 [Step 306]. Next, the second end 150 may be rotated to a desired angle about the pivot point 152 and locked to said angle via the locking member 154 of the second end 150 [Step 308]. Then, the button 144 of the handle 140 may be pressed, activating the pump 172 to push the cleaning solution through the nozzle 164 and onto a cleaning surface, such as but not limited to the windshield of a commercial vehicle [Step 310]. Next, the button 144 may be pressed to activate the motor 170 which spins the bristles 162 to remove dirt and debris from the windshield of a commercial vehicle [Step 312]. Finally, the cleaning blade 166 may be scraped along the cleaning surface to remove any remaining water, cleaning solution, dirt, or other debris [Step 314].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorized cleaning brush device” and “device” are interchangeable and refer to the motorized cleaning brush device 100 of the present invention.

Notwithstanding the forgoing, the motorized cleaning brush device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized cleaning brush device 100 as shown in the FIGS. are for illustrative purposes only, and that many other sizes and shapes of the motorized cleaning brush device 100 are well within the scope of the present disclosure. Although the dimensions of the motorized cleaning brush device 100 are important design parameters for user convenience, the motorized cleaning brush device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized cleaning brush device comprising:
a body comprised of a handle;
a head comprised of a bristle;
a motor;
a battery; and
a button.

2. The motorized cleaning brush device of claim 1, wherein the bristle is removable from the head.

3. The motorized cleaning brush device of claim 1, wherein the body is comprised of a handle.

4. The motorized cleaning brush device of claim 1, wherein the body is comprised of a telescopic body.

5. The motorized cleaning brush device of claim 4, wherein the telescopic body is comprised of a locking member.

6. The motorized cleaning brush device of claim 1, wherein the button activates the motor.

7. A motorized cleaning brush device comprising:
a hollow body comprised of a handle;
a head attached to the body via a pivot point, the head comprised of a bristle and a nozzle;
a motor;
a pump;
a battery; and
a button.

8. The motorized cleaning brush device of claim 7, wherein the hollow body is comprised of a telescopic body.

9. The motorized cleaning brush device of claim 8, wherein the telescopic body is comprised of a first locking member that secures the telescopic body at a fixed length.

10. The motorized cleaning brush device of claim 7, wherein the pivot point is comprised of a hinge.

11. The motorized cleaning brush device of claim 7, wherein the pivot point is comprised of a ball and socket joint.

12. The motorized cleaning brush device of claim 7, wherein the pivot point is comprised of a second locking member that locks the pivot point at an angle.

13. The motorized cleaning brush device of claim 7, wherein the motor rotates the bristle.

14. The motorized cleaning brush device of claim 7, wherein the pump expels a liquid from within the hollow body and out of the nozzle.

15. The motorized cleaning brush device of claim 7, wherein the head is comprised of a cleaning blade.

16. A method of using a motorized cleaning brush device, the method comprising the following steps:
providing a motorized cleaning brush device comprised of a body comprised of a head comprised of a bristle, and a motor;
filling the body with a liquid cleaning solution;
pressing a button of the motorized cleaning brush device to expel the liquid cleaning solution out of a nozzle of the head;
pressing the button to activate the motor to spin the bristle; and
cleaning a surface via the bristles.

17. The method of using a motorized cleaning brush device of claim 16, wherein the motorized cleaning brush device is comprised of a cleaning blade.

18. The method of using a motorized cleaning brush device of claim 17 further comprised of a step of using the cleaning blade to scrape the surface.

19. The method of using a motorized cleaning brush device of claim 17 further comprised of a step of locking the body at a length via a locking member.

20. The method of using a motorized cleaning brush device of claim 16, wherein the body is comprised of a pivot point.
